(19) United States
(12) Patent Application Publication
(10) Pub. No.: US 2024/0219568 A1
(43) Pub. Date: Jul. 4, 2024

(54) ITERATIVE LEARNING CONTROL

(71) Applicant: Luminar Technologies, Inc., Orlando, FL (US)

(72) Inventor: Eric James Dahlberg, Eden Prairie, MN (US)

(21) Appl. No.: 18/545,826

(22) Filed: Dec. 19, 2023

Related U.S. Application Data
(60) Provisional application No. 63/436,968, filed on Jan. 4, 2023.

(51) Int. Cl. G01S 17/88; G06N 20/00

(52) U.S. Cl. CPC G01S 17/88; G06N 20/00

(57) ABSTRACT

A system includes a light emitter configured to emit light pulses. The system includes a controller configured to control positions of the emitted light pulses based on a selected reference profile. The controller includes an iterative learning controller configured to provide an error correction signal based on one or more iterative learning functions that correspond to the selected reference profile. The system includes a detector configured to provide one or more detection signals in response to a detection of a return pulse corresponding to at least one of the emitted light pulses.

### CROSS REFERENCE TO OTHER APPLICATIONS

This application claims priority to U.S. Provisional Patent Application No. 63/436,968 entitled ITERATIVE LEARNING CONTROL IN LIDAR SYSTEMS filed Jan. 4, 2023 which is incorporated herein by reference for all purposes.

### BACKGROUND OF THE INVENTION

LiDAR systems may be used to map local environments, detect the location of objects within the local environments, track movement of objects within the local environments, etc. In general, a time-of-flight LiDAR systems include a transmitting signal chain (e.g., an emitter) and a receiving signal chain (e.g., a detector). The emitter may emit a light pulse (e.g., photons) and the receiving signal chain may receive and measure the amplitude and nature of a return pulse. The return pulse may include at least a portion of the light pulse (e.g., a subset of the photons) that is reflected by an object or feature (e.g., a target) in the local environment. The distance that the photons of the return pulse travel, and by extension the distance of the emitter to the target, can be determined based on the amount of time between transmission of the light pulse to detection of the return pulse.

### BRIEF DESCRIPTION OF THE DRAWINGS

Various embodiments of the invention are disclosed in the following detailed description and the accompanying drawings.

FIG. 1 is a schematic diagram of an embodiment of LiDAR system.

FIG. 2 is a schematic diagram of an embodiment of an emitter channel of the LiDAR system of FIG. 1.

FIG. 3 is a schematic diagram of an embodiment of an output system of the detector channel of FIG. 2.

FIG. 4 is a schematic diagram of an embodiment of an output controller of the output system of FIG. 3.

FIG. 5 is a graph showing an example of measured output position to a set of reference positions.

FIG. 6 is another graph showing an example of measured output position to another set of reference positions.

FIG. 7 is a graph showing example error table values based on the measured outputs of the graph of FIG. 5.

FIG. 8 is a graph showing example iterative learning values based on the measured outputs of the graph of FIG. 5.

FIG. 9 is a graph showing example error values based on the measured outputs of the graph of FIG. 6.

FIG. 10 is a graph showing example iterative learning values based on the measured outputs of the graph of FIG. 6.

FIG. 11 a graph depicting an example output measurements of the output system of FIG. 3.

FIG. 12 is a flow diagram of an embodiment of a LiDAR calibration method or process.

FIG. 13 is a flow diagram of an embodiment of a LiDAR scanning method or process.

The schematic drawings are not necessarily to scale.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As described herein, iterative learning control of LiDAR systems can be accomplished with reduced memory requirements and decreased convergence times using LiDAR systems that are calibrated using methods and processes described herein. Generally, LiDAR systems may include an emitter and a detector. The emitter may emit a light pulse and, after being reflected off of an object in a local environment, at least a portion of the emitted light pulse may be received by the detector as a return pulse. The emitter may be configured to emit a light pulse within a field of view of the LiDAR system based on a reference profile. Calibration methods described herein may determine one or more iterative learning functions for the reference profile. The one or more iterative learning functions may be provided to an iterative learning controller of the LiDAR system when the reference profile is selected. Furthermore, the iterative learning controller of the LiDAR system may substitute functions and coefficients for error tables and iterative learning tables. Accordingly, memory requirements and convergence times of the iterative learning controller of the LiDAR system may be reduced.

Described herein, among other things, is a method for calibrating a LiDAR system. The method may comprise providing a reference profile comprising a plurality of reference positions to an iterative learning controller of the LiDAR system and scanning a field of view of the LiDAR system based on the reference profile using an output system of the LiDAR system. The output system may comprise the iterative learning controller. The method may further comprise sampling an output position of the output system during scanning of the field of view based on the reference profile to provide a plurality of measured positions and comparing the plurality of measured positions to the plurality of reference positions to generate an iterative control data set corresponding to the reference profile. The method may further include determining one or more iterative learning functions based on the iterative control data set.

In general, in one aspect, the present disclosure describes a method comprising providing a reference profile comprising a plurality of reference positions to an output controller of a LiDAR system. The output controller may comprise an iterative learning controller. The method may further comprise providing one or more iterative learning functions based on the reference profile and scanning a field of view of the LiDAR system based on the reference profile and one or more iterative learning functions using an output system of the LiDAR system. The output system may comprise the iterative learning controller. The method may further comprise adjusting the one or more iterative learning functions based on an output of the output system and the reference profile.

In general, in another aspect, the present disclosure describes a LiDAR system comprising an emitter to emit light pulses within a field of view of the LiDAR system and a detector to provide one or more detection signals in response to receipt of a return pulse corresponding to light pulses emitted by the emitter. The emitter may comprise a light emitter to generate the light pulses and an output system operatively coupled to the light emitter to control a position of the emitted light pulses within the field of view based on a selected reference profile. The output system may comprise an iterative learning controller configured to provide an error correction signal based on one or more iterative learning functions that correspond to the selected reference profile.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

Reference will now be made in greater detail to various embodiments of the subject matter of the present disclosure, some embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

Light Detection and Ranging (LiDAR) systems can be useful for applications in which range information (e.g., distances, etc.) or location information may be desirable. LiDAR systems may be configured to determine the range information of a target (e.g., an object or feature) using a light pulse emitted at the target and receiving a return pulse that includes a portion of the light pulse that is reflected by the target back to the LiDAR system. The range information may be detected or determined based on a time-of-flight and/or waveform characteristics of the return pulse. The time-of-flight may be the time between emission of the light pulse and receipt of the return pulse.

LiDAR applications may include autonomously piloted or driver assisted vehicle guidance systems, topographical mapping, surveying, and so on. LiDAR systems can be useful in generating a three-dimensional (3D) point cloud representation of the surrounding environment in the applicable field of view (FoV). The light wavelengths used in LiDAR system may range from ultraviolet wavelengths to near infrared wavelengths (e.g., 250 nanometers, nm to 1500 nm, or greater) with native light frequencies up to the terahertz (THz, 1012 Hz) range. Other wavelength and frequency ranges can also be used.

In general, LiDAR systems my include any suitable type or form of LiDAR. One form of LiDAR that can be used may be referred to as coherent pulsed LiDAR. LiDAR systems that use coherent pulsed LiDAR use coherent light (e.g., a beam of photons that are all at the same phase and frequency) and detects range information based on phase differences in the reflected light. Such systems may use a dual (IQ) channel detector with an I (in-phase) channel and a Q (quadrature) channel. Other forms of LiDAR systems can be used, however, including non-coherent light systems that may incorporate one or more detection channels.

LiDAR systems may follow a repeating scanning reference profile to generate a three-dimensional point cloud representation of the surrounding environment within their FoV. A scanning reference profile may instruct an emitter or emitter channel of a LiDAR system various positions within the FoV to scan. In general, a selected reference profile may be configured such that distribution of resolution across a scanning mechanism span or field of view is optimized for typical LiDAR use cases. Additionally, selected reference profiles can be reconfigured or adjusted for a plurality of use cases. For example, a scanning profile for a vehicle may be selected such that the vertical resolution of a scan is concentrated about the horizon. In other words, horizontal scan lines may be positioned closer together at a vertical location in the FoV where the horizon is expected to be. However, when a pitch of the vehicle changes relative to the position of the horizon, the horizon may no longer be located within the portion of the FoV that includes the higher density of horizontal scanlines as instructed by the original scanning reference profile. Accordingly, the profile can be reconfigured to allow the high concentration of vertical scanlines follows the horizon as a pitch of the vehicle changes.

To enable LiDAR systems to learn a response to a repeating scanning profile and minimize tracking error, an iterative learning controller may be used. In general, iterative learning controllers may store an error table and an iterative learning controller (ILC) table. Typically, error tables and iterative learning controller tables consume memory as a function of the time duration of the repeating profile and a servo position sample rate. In general, iterative learning controllers may consume a relatively large volume or amount of memory and when a profile is reconfigured, e.g., when a pitch of a vehicle changes relative to the horizon, the iterative learning controller may require a significant amount of time to relearn its error compensation.

To reduce the time that it takes to relearn error compensation, a calibration method may use iterative learning control to pre-learn a set of feed forward tables. To reduce memory requirements, error tables and ILC tables may be approximated by piecewise functions. Methods and systems described herein may provide iterative learning control for LiDAR systems such that memory requirements are reduced and the time that it takes for measured outputs to converge to reference inputs is reduced.

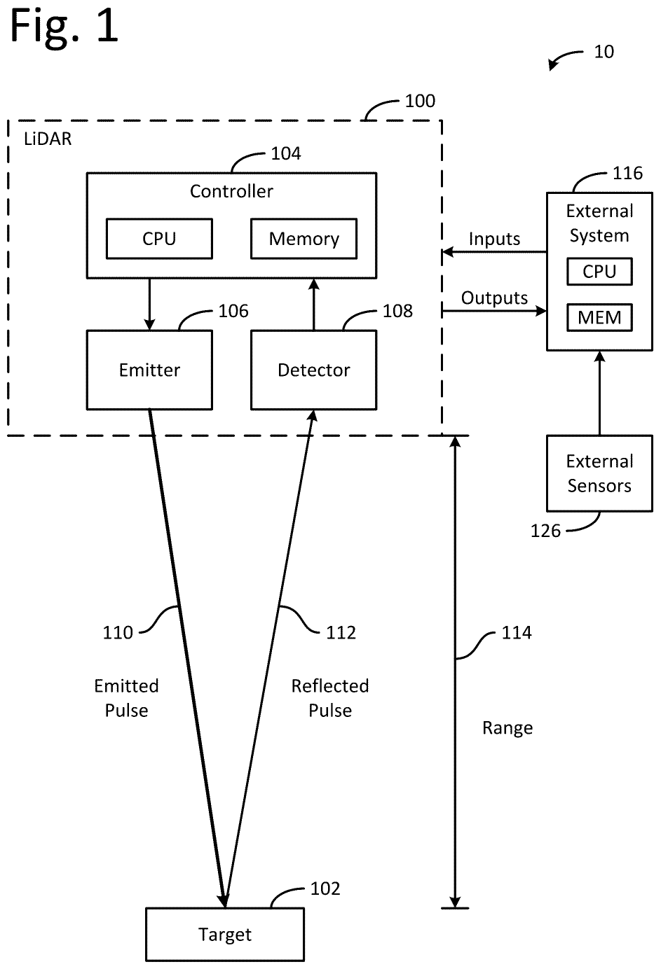

An embodiment of a LiDAR system is depicted in FIG. 1. The LiDAR system 100 may be configured to obtain range information regarding a target 102 that is located distal from the LiDAR system 100. The range information may be used for any suitable application or applications including, for example, topography, archeology, geology, surveying, geography, forestry, seismology, atmospheric physics, laser guidance, automated driving and guidance systems, closed-loop control systems, etc.

The LiDAR system 100 may include a controller 104 to control functionality of the LiDAR system 100. In other words, the controller 104 may provide top level control of the LiDAR system 100. The controller may include any suitable hardware or software to control functionality of the LiDAR system 100. The controller 104 may include, for example, one or more processors, logic gates, digital signal processors (DSPs), field programmable gate arrays (FPGAs), system on chip (SOC) integrated circuits, application specific integrated circuits (ASICs), gate logic, reduced instruction set computers (RISCs), etc.

The controller 104 can use the one or more processors with associated programming (e.g., software, firmware) stored in a local memory or data storage which provides instructions that are executed by the programmable processor(s) during operation. The controller 104 may include the memory for data storage and access to processing programs or routines that may be employed to carry out the techniques, processes, and algorithms for range detection, calibration, or amplitude reporting correction. For example, processing programs or routines may include programs or routines for determining one or more parameters (e.g., calibration parameters), amplitude reporting, amplitude correction, determining active ranges of gain stages, determining correction factors for gain stages, determining location, filtering, computational mathematics, matrix mathematics, Fourier transforms, compression algorithms, calibration algorithms, inversion algorithms, signal processing algorithms, normalizing algorithms, deconvolution algorithms, averaging algorithms, standardization algorithms, comparison algorithms, vector mathematics, or any other processing required to implement one or more embodiments as described herein. Further, for example, data stored in memory may include, amplitudes, calibration parameters, active ranges settings, correction factors, coefficients, point cloud data, emitter settings, detector settings, thresholds, or any other data required to implement one or more embodiments described herein.

The controller 104 may also include or be operatively couplable to a communication interface to communicate with one or more external devices (e.g., external system 116). The communication interface may include any suitable hardware or devices to provide wired or wireless communication with the one or more external devices. For example, the communication interface may include one or more of a receiver, transmitter, transceiver, ethernet port, Universal Serial Bus (USB) port, cables, controller, or other device to facilitate wired or wireless communication. The communication interface may facilitate communication using any suitable protocol or protocols. For example, the communication interface may utilize Ethernet, Recommended Standard 262, Universal Asynchronous Receiver Transmitter or Universal Synchronous Asynchronous Receiver Transmitter (UART/USART), USB, BLUETOOTH, Wi-Fi, Near Field Communication (NCF), etc. The communication interface may allow communication between the LiDAR system 100 and external devices such as computing apparatus, control systems, emitters, databases, etc.

An emitter 106, also sometimes referred to as an energy source circuit or transmission signal chain, may direct electromagnetic radiation in the form of light pulses or laser pulses toward the target 102. A detector 108, also sometimes referred to as a sensor or receiver signal chain, senses return pulses or portions of the light pulses reflected back to the LiDAR system 100 from the target 102. The controller 104 may direct operation of the emitted light pulses from the emitter 106, denoted by arrow 110, and decodes information from the return pulses obtained back from the target, as denoted by arrow 112.

Arrow 114 depicts the actual, true range information associated with the intervening distance (or other range parameter) between the LiDAR system 100 and the target 102. Depending on the configuration of the LiDAR system 100, the range information can include the relative or absolute speed, velocity, acceleration, distance, size, location, reflectivity, color, surface features and/or other characteristics of the target 102 with respect to the LiDAR system 100.

The decoded range information can be used to carry out any number of useful operations, such as, for example, LiDAR system calibration, amplitude correction, calibration parameter determination, controlling a motion, input or response of an autonomous vehicle, generating a topographical map, recording data into a data structure for further analysis and/or operations, etc. The controller 104 may perform these operations directly, or can communicate the range information to an external system 116 for further processing and/or use.

In some cases, inputs supplied by the external system 116 can activate and configure the LiDAR system 100 to perform one or more tasks or operations. For example, the external system 116 may activate or configured the LiDAR system to capture particular range information, perform a calibration routine, perform a diagnostic routine, etc. The particular range information, calibration data, diagnostic data, or other data requested or determined may be returned to the external system 116 by the controller 104.

The exact configuration of the external system 116 is not limiting and essentially any device capable of providing suitable computing capabilities and instructions (e.g., calibration instructions, range information instructions or requests, calibration parameter determination, active range determination, correction factor determination, amplitude reporting coefficients, etc.) may be used. Further, various peripheral devices, such as a computer display, mouse, keyboard, memory, printer, scanner, etc. are contemplated to be used in combination with the external system 116. In one or more embodiments, the external system 116 may form part of a calibration system and can be used to calibrate capabilities of the LiDAR system. For example, the external system may be used to calibrate range finding capabilities, amplitude reporting, emitter capabilities, location determination capabilities, etc. In one or more embodiments, the external system may form a portion of a closed-loop control system and the range information output by the LiDAR system 100 can be used by the external system 116 to adjust the position of a moveable element.

The external system 116 may include or be operatively couplable to additional devices or apparatus to facilitate or augment the processes and/or capabilities of the external system 116 or LiDAR system 100. For example, the external system may include or be operatively coupled to external sensors 126. The external sensors 126 can provide additional inputs used by the external system 116 and/or the LiDAR system 100. External sensors 126 may include position sensors (e.g., a global positioning system, linear position sensors, angular position sensors, rotary position sensors, etc.), optical sensors, acoustic sensors (e.g., microphones, ultrasonic sensors, etc.), temperature sensors, etc. Data or information provided by the external sensors 126 may facilitate or augment the processes and/or capabilities of the external system 116 or LiDAR system 100. Furthermore, the external system 116 may be operatively couplable to calibration systems or fixtures to facilitate calibration of the LiDAR system 100.

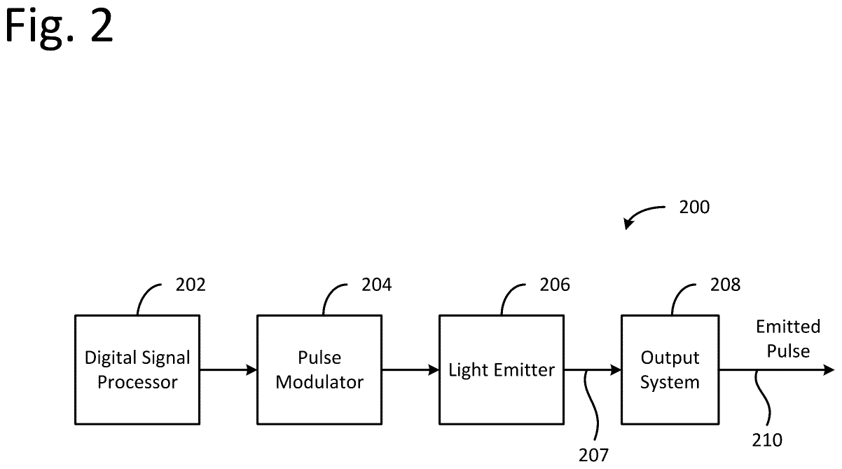

The emitter 106 may include one or more emitter channels as depicted in FIG. 2. FIG. 2 shows an embodiment of an emitter channel 200 that can be incorporated into the LiDAR system 100 of FIG. 1. The emitter channel 200 may define at least a portion of the emitter 106. In other words, the emitter 106 may include any of the components of the emitter channel 200.

The emitter channel 200 may include a digital signal processor (DSP) 202 that provides adjusted inputs to a pulse modulator 204 (e.g., a laser modulator) that may adjust a light emitter 206 (e.g., a laser, a laser diode, etc.) that emits electromagnetic radiation (e.g. light 207) in a desired spectrum. The emitted light 207 may be processed by an output system 208 to issue a light pulse 210 in a desired direction and/or position. The light pulse 210 may include a laser pulse, coherent light, non-coherent light, swept light, etc.

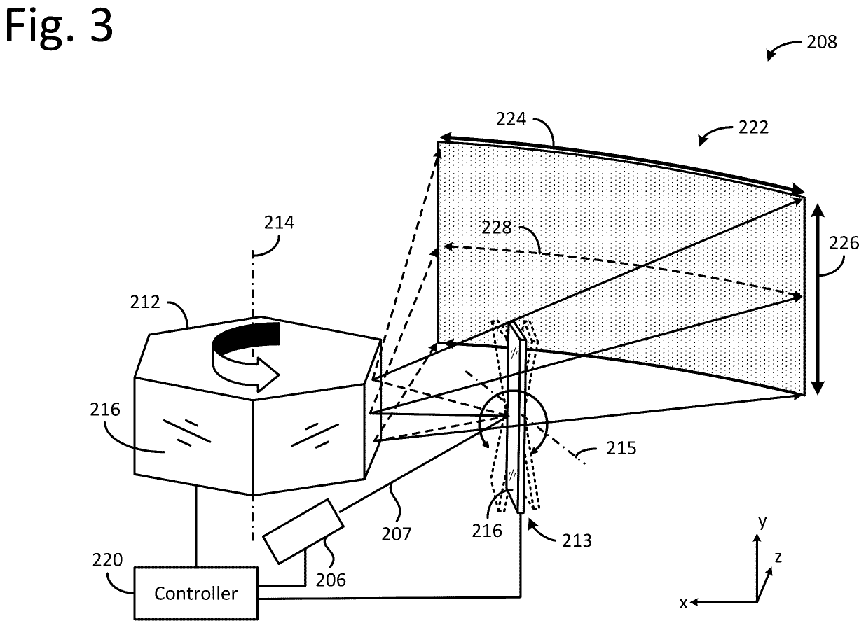

The output system 208 is depicted in greater detail in FIG. 3. FIG. 3 shows output system 208 that may be operatively coupled to the light emitter 206 to control a position of the emitted light pulses 210 within the field of view (FoV) 222 of the LiDAR system 100. The output system 208 may include one or more scanning mirrors to direct light 207 emitted by emitter 206 to points within the FoV 222. The FoV 222 may be defined by a horizontal range or horizontal viewing angle 224 and a vertical range or vertical viewing angle 226. The horizontal and vertical viewing angles 224, 226 may include any suitable range or ranges. For example, the horizontal viewing angle 224 may be at least 45 degrees and no greater than 90 degrees. In one or more embodiments, the horizontal viewing angle 224 may be at least 55 degrees and no greater than 65 degrees. Further, for example, the vertical viewing angle 226 may be at least 10 degrees and no greater than 40 degrees. In one or more embodiments, the vertical viewing angle 226 may be at least 25 degrees and no greater than 35 degrees.

As shown, the output system 208 may include a horizontal-scanning mirror 212 and vertical-scanning mirror 213 that each include one or more reflective surfaces 216. Each of the scanning mirrors 212, 213 can be positioned to direct incident light at a selected angle to redirect light 207 and provide the light pulse 210 at particular points within the FoV 222. The vertical-scanning mirror 213 may be rotatable about an axis 215 to control a vertical position of the light pulse 210 within the FoV 222. In other words, the vertical-scanning mirror 213 may be rotated to control the output of light pulses 210 within the vertical viewing angle 226. As shown, the vertical-scanning mirror 213 may include a polygon that can be mechanically rotated about the axis 215. vertical-scanning mirror 213 may include the reflective surface 216 adapted to direct incident light 207 as a reflected stream or light pulse 210 at a selected angle responsive to the rotational orientation of the vertical-scanning mirror 213. At neutral position (e.g., an angle of 0 degrees), the vertical-scanning mirror 213 may direct light pulses 210 to a point along middle of the vertical range 226 indicated by the dashed line 228. Adjustment of the angle of the vertical-scanning mirror 213 from the neutral position may allow the light pulses 210 to be directed to any point within the vertical range 226. The impingement of light 207 and rotational angle of the vertical-scanning mirror 213 may be coordinated such that the light pulses 210 can be swept across the vertical range 226 of the FoV 222 of the LiDAR system 100 in a desired pattern (e.g., scan rate, scan density, etc.)

In contrast, the horizontal-scanning mirror 212 may be rotatable about an axis 214 to control a horizontal position of the light pulse within the FoV 222. In other words, the horizontal-scanning mirror 212 may be rotated to control the output of light pulses 210 within the horizontal viewing angle 224. As shown, the horizontal-scanning mirror 212 may include a polygon that can be mechanically rotated about the central axis 214. The horizontal-scanning mirror 212 may include the reflective surfaces 216 adapted to direct incident light 207 as a reflected stream or light pulse 210 at a selected angle responsive to the rotational orientation of the horizontal-scanning mirror 212. As shown, the polygonal shape of the reflector may be characterized as a hexagon with six reflective sides, but any number of different configurations, shapes, sides, or other designs can be used. The impingement of light 207 and rotational angle of the horizontal-scanning mirror 212 may be coordinated such that the light pulses 210 can be swept across the horizontal range 224 of the FoV 222 of the LiDAR system 100 in a desired pattern (e.g., scan rate, scan density, etc.). The emitter 106 or output system 208 may include an output controller 220 to control the rotation or position of the scanning mirrors 212, 213 to scan the FoV 222 based the desired pattern.

In general, the scanning mirrors 212, 213 may be rotated about their respective axes 214, 215 using one or more actuators. In other words, each of the scanning mirrors 212, 213 may include one or more actuators to position the reflective surfaces 216 to scan the FoV 222 based the desired pattern. The one or more actuators may include any suitable device or devices such as, for example, one or more motors, servos, position sensors, etc. The output controller 220 may be operatively coupled to the scanning mirrors 212, 213 to control the emission of light pulses 210 based on a reference profile. The output controller 220 may be configured to control the scanning mirrors 212, 213 to achieve a desired reflection angle. The output controller 220 may further be configured to provide feedback control to correct positional errors of the output system 208.

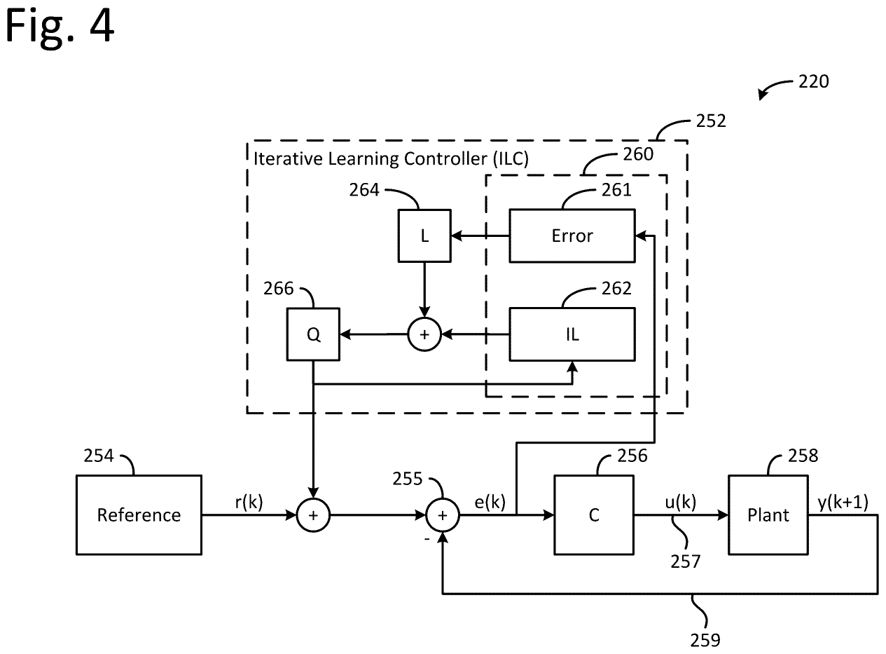

The output controller 220 is depicted in greater detail in FIG. 4. The output controller 220 may include a feedback controller 256 and an iterative learning controller (ILC) 252. The feedback controller 256 may receive a reference input 254 or signal based on a reference profile and provide a control signal 257 to what is generally referred to as a plant 258. In general, the plant of feedback control systems includes one or more actuators and one or more processes. In the context of the emitter 106 and the output system 208, the actuators of the plant 258 may refer to actuators (e.g., servos) used to control the position and/or orientation of the scanning mirrors 212, 213. The actuators may also refer to the scanning mirrors 212, 213 themselves. The process of the plant 258 may refer to the position of the servo, the position or rotational angle of each of the scanning mirrors 212, 213, and/or the position of the light pulse 210 in the FoV 222 of the LiDAR system 100.

The plant 258 may provide an output that can be measured or otherwise sensed. The output may be a measurement of the position of the servo, the position or rotational angle of each of the scanning mirrors 212, 213, and/or the position of the light pulse 210 in the FoV 222. The measurement of the output may be provided as a feedback signal 259 and compared to the reference signal 254 using a comparator 255. The comparator 255 may determine a difference or error between the measured output based on the reference input 254 and the feedback signal 259 and provide the error to the controller 256. The controller 256 may further be configured to adjust the control signal 257 based on the determined error. However, even with such feedback control, transient errors may still exist in outputs (e.g., servo position, mirror position, light pulse position/direction) of the output system 208. Accordingly, output controller 220 may further include the ILC 252.

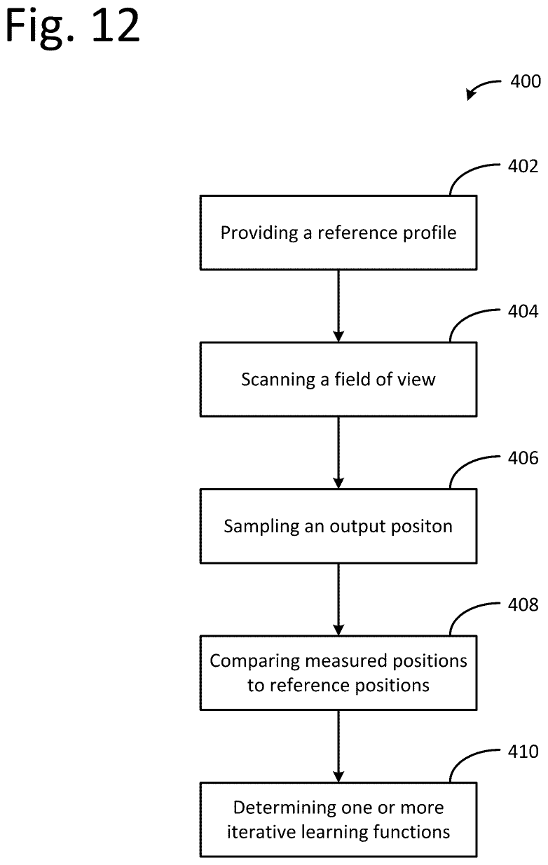

The ILC 252 may include memory or data storage 260. During a calibration method (e.g., method 400 of FIG. 12) the ILC 252 may store error feedforward tables at error block 261 and iterative learning tables at iterative learning (IL) block 262. Error feedforward tables may receive an error signal and record the error of an actuator for each iteration (e.g., light pulse 210). Iterative learning tables may receive an output of the ILC 252 and record the output for each iteration. To provide the output of the ILC 252, the most recent ILC output and error value for the current reference value may be provided. The most recent ILC output may be provided by the IL block 262 and the most recent error value may be provided by the error block 261.

The ILC 252 may include one or more filters to provide the ILC output based on the error value and the most recent ILC output corresponding to the current reference value. The ILC 252 may include a learning filter (L) 264 to add an error compensation to the ILC value provided by the IL block 262 to provide an ILC compensation signal. The error compensation may be determined based on the error value provided by the error block 261. For example, if the magnitude of error is high, the learning filter 264 may provide or add a correspondingly high error compensation to the ILC value. The ILC 252 may further include a low-pass Q-filter (Q) 266 to receive the compensation signal and provide an ILC output signal. The low-pass Q-filter 266 may filter out noise that can be added to the signals of the iterative learning controller. In turn, the ILC output signal may be added to the reference signal.

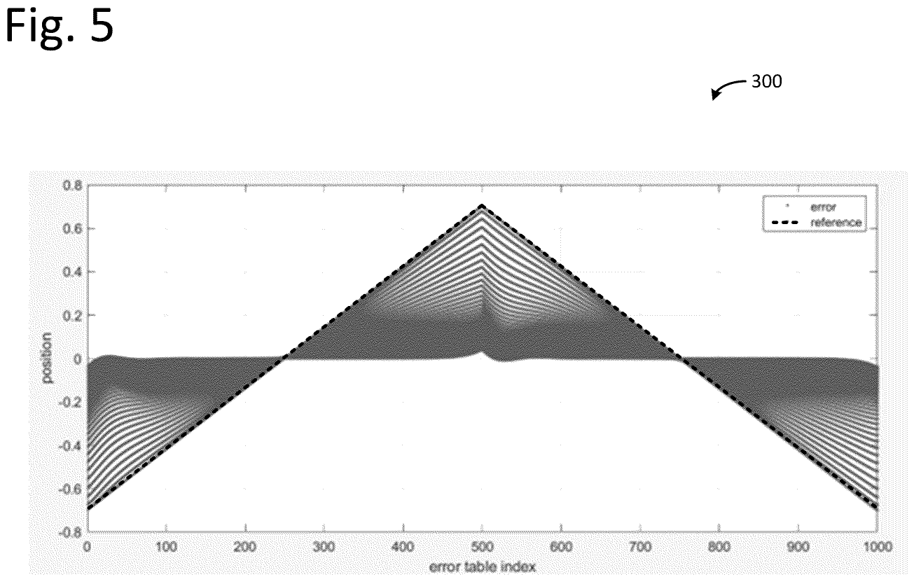

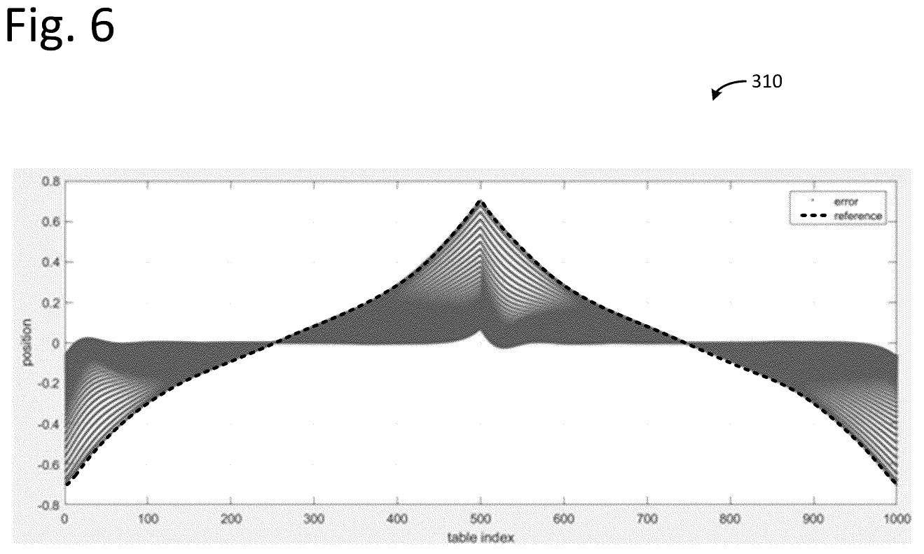

Examples of iterative learning control and accompanying error tables and iterative learning tables are depicted in FIGS. 5-9. FIG. 5 shows a graph 300 that depicts actual position compared to a reference position over multiple iterations of executing a first reference profile using an ILC. FIG. 6 shows another graph 320 that depicts actual position compared to a reference position over multiple iterations of executing a second reference profile using an ILC. As shown in each of graphs 300, 310, the error or difference between the actual position and the reference position diminishes over successive iterations and the actual position converges to the reference position of the reference profiles.

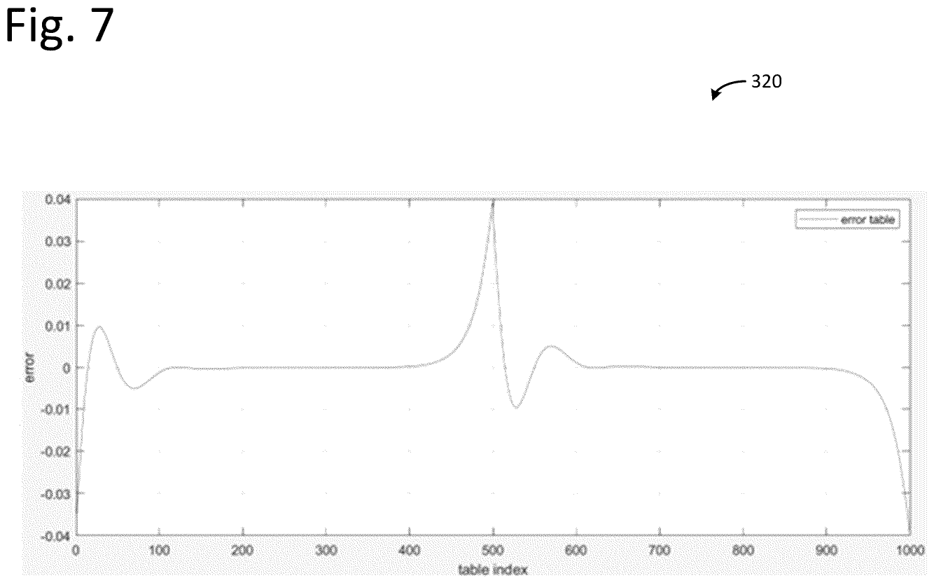

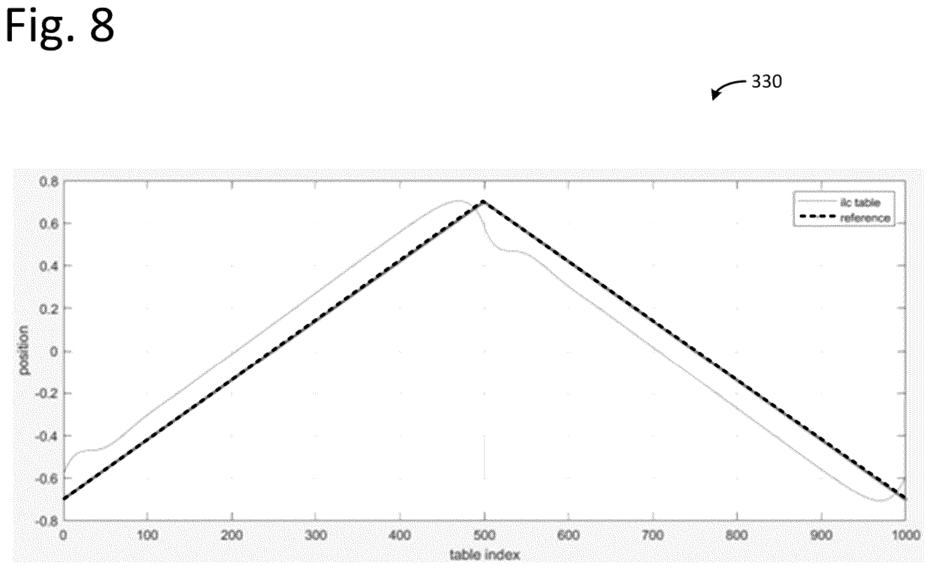

FIGS. 7 and 8 show examples of an error table and iterative learning table as result of converging to the reference positions of the first reference profile depicted in graph 300 of FIG. 5. FIG. 7 shows a graph 320 that depicts error table values for each table index or reference position (k) from the first reference profile. The error table values of graph 320 may refer to gain adjustments added by the learning filter 264 corresponding to each table index. FIG. 8 shows a graph 330 that depicts an example of the iterative learning values added to the reference signal to correct for transient errors of the output system 208 for the first reference profile. As shown, to correct for transient errors, the ICL introduces phase lead relative to the reference profile to minimize error.

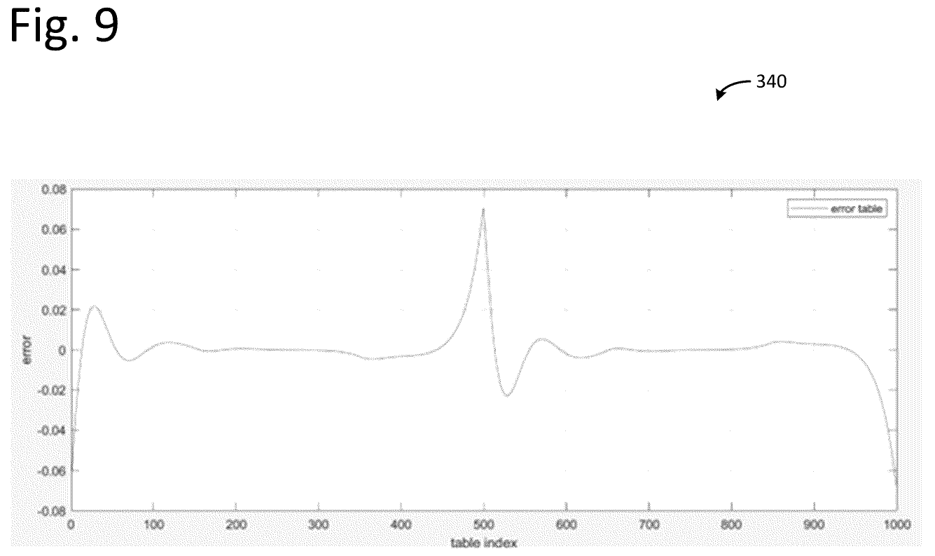

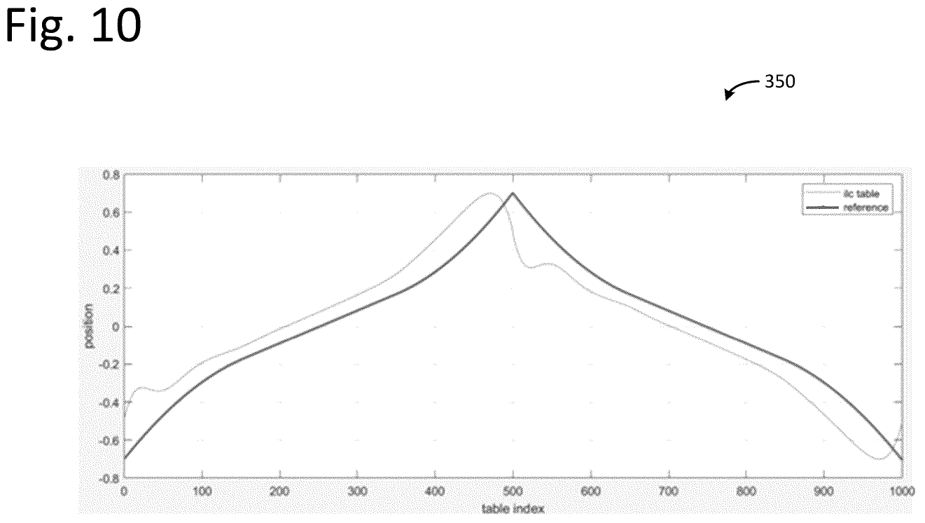

FIGS. 9 and 10 show examples of an error table and iterative learning table as result of converging to the reference positions of the second reference profile depicted in graph 300 of FIG. 6. FIG. 9 shows a graph 340 that depicts error table values for each table index or reference position (k) from the first reference profile. The error table values of graph 320 may refer to gain adjustments added by the learning filter 264 corresponding to each table index. FIG. 10 shows a graph 350 that depicts an example of the iterative learning values added to the reference signal to correct for transient errors of the output system 208 for the second reference profile. As shown, to correct for transient errors, the ICL introduces phase lead relative to the reference profile to minimize error.

Typical representations of error feedforward tables may require significant space in memory 260 to store a number of entries for each error table and iterative learning table equal to the sample rate of the actuator position times the duration of a given reference profile. However, the calibration methods described herein may allow error values and iterative learning values to be provided by the blocks 261, 262 of the ILC 252 while taking up significantly less space in memory 260 than typical error feedforward tables and iterative learning tables.

For example, the error table values of FIGS. 7 and 9 may be represented or approximated by a piecewise function and coefficients may be determined for each of the first and second reference profile to adjust the piecewise function based on the particular reference profile selected. Similarly, the iterative learning values of FIGS. 8 and 10 may also be approximated by a piecewise function and coefficients may be determined for each of the first and second reference profile to adjust the piecewise function based on the particular reference profile selected. Accordingly, calibration can be done for any suitable number of reference profiles and coefficients for each of the error piecewise function and the iterative learning piecewise function may be determined for each of the number of reference profiles. The coefficients may be stored in memory 260 of the ILC 252, the controller 104, or the external system 116.

Furthermore, error correction provided by ILC 252 during calibration may be incorporated into or otherwise used to modify reference profiles to significantly reduce the time to convergence when a new profile is selected during runtime. Accordingly, the reference profile generator 254 may provide reference signals or values that are adjusted based on calibration of the particular LiDAR system rather than raw reference signals or values that are generic to a given LiDAR system.

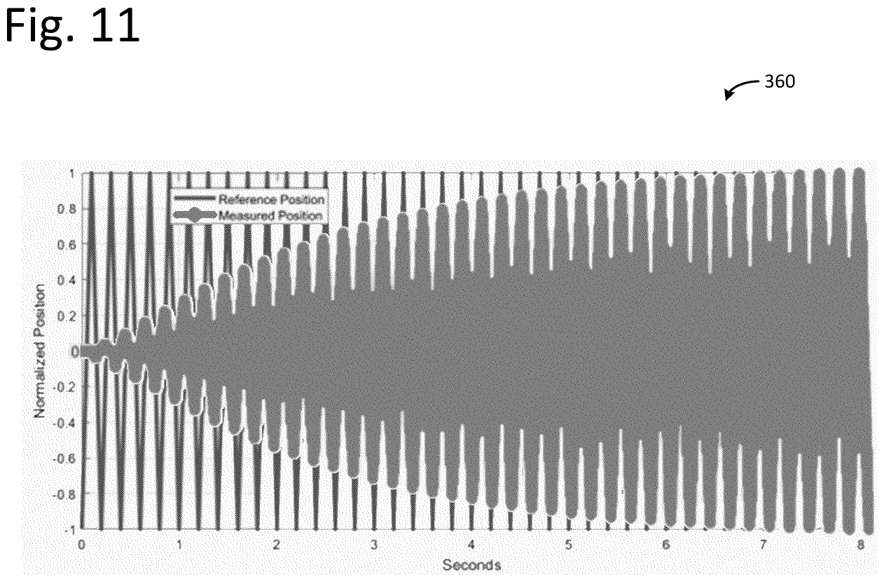

Accordingly, LiDAR systems (e.g., LiDAR system 100) that utilize ILCs and calibration methods as described herein may require less memory and achieve relatively quick error convergence times compared to typical LiDAR systems. For example, LiDAR systems as described herein may achieve error convergence times of 8 seconds or less as depicted in FIG. 11. FIG. 11 shows a graph 360 that compares a reference position to an actual position of actuators of a LiDAR system that utilizes the ILC 252 and calibration methods as described herein. As shown, the reference position and measured position of graph 360 converges in less than 8 seconds.

A method or process 400 for calibrating a LiDAR system using ILC is shown in FIG. 12. The method 400 may be carried out using any suitable calibration system and LiDAR system (e.g., LiDAR system 100 of FIG. 1).

At 402, the method 400 may include providing a reference profile comprising a plurality of reference positions to an output controller (e.g., output controller 220) of the LiDAR system. The output controller may include an iterative learning controller (e.g., ILC 252 of FIG. 4). The reference profile may be provided by the controller 104 or the external system 116. The reference profile may indicate a scanning resolution, density, sample rate, or other parameters for the emitter 106.

At 404, the method 400 may include scanning a field of view (e.g., FoV 222 if FIG. 3) of the LiDAR system based on the reference profile using the output system. The field of view may be scanned multiple times. In other words, the field of view may be scanned according to the reference profile to provide multiple iterations or scan frames.

At 406, the method 400 may include sampling an output position of the output system during scanning of the field of view based on the reference profile to provide a plurality of measured positions. Sampling the output position may include measuring a position of one or more servos, an angle of one or more mirrors, a position of an emitted pulse within the field of view, etc. Sampling the output position may include storing each of the plurality of measured positions in a table.

At 408, the method 400 may include comparing the plurality of measured positions to the plurality of reference positions to generate an iterative control data set corresponding to the reference profile. The iterative control data set may include a plurality of error values corresponding to each reference value of the reference profile. The plurality of error values may be difference between corresponding measured values and reference values. The iterative control data set may also include a plurality iterative learning values. Each of the plurality of iterative learning values may correspond to an output of the iterative learning controller for each reference value.

At 410, the method 400 may include determining one or more iterative learning functions based on the iterative control data set. The iterative learning functions may include one or more piecewise approximations or piecewise functions. The one or more iterative learning functions may include an error feedforward piecewise function. The one or more iterative learning functions may include an iterative learning piecewise function. The one or more iterative learning functions may also include a set of coefficients that corresponds to the reference profile.

The method may further include storing the iterative learning functions in memory. The one or more iterative learning functions my be stored in the output controller, the controller of the LiDAR system, or in an external system. The method may further include incorporating the one or more iterative learning functions into the reference profile.

The method 400 may be utilized for any suitable number of reference profiles. Accordingly, one or more iterative learning functions may be determined for each reference profile that may be used by a LiDAR system or external system. Subsequently, any of such iterative learning functions may be utilized when using the LiDAR system and associated reference profiles.

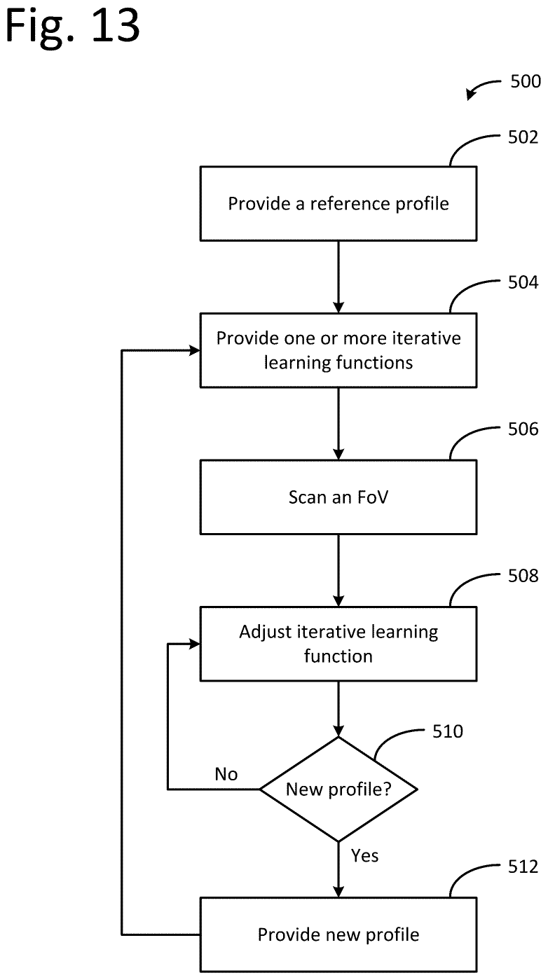

A method or process 500 for a LiDAR scanning method using ILC is shown in FIG. 13. The method 500 may be carried out using any suitable LiDAR system (e.g., LiDAR system 100 of FIG. 1).

At 502, the method 500 may include providing a reference profile comprising a plurality of reference positions to an output controller (e.g., output controller 220) of the LiDAR system. The output controller may include an iterative learning controller (e.g., ILC 252).

At 504, the method 500 may include retrieving one or more iterative learning functions based on the reference profile. The one or more iterative learning functions may be retrieved or otherwise provided by the controller 104 or the external system 116. Retrieving the one or more iterative learning functions may include loading an error piecewise function into memory of the iterative learning controller (e.g., error block 261 of FIG. 4). Retrieving the one or more iterative learning functions may include loading a set of coefficients into memory of the iterative learning controller (e.g., error block 261 of FIG. 4) to adjust the error piecewise function for the provided reference profile. Retrieving the one or more iterative learning functions may include loading an iterative learning piecewise function into memory of the iterative learning controller (e.g., IL block 262 of FIG. 4). Retrieving the one or more iterative learning functions may include loading an error piecewise function into memory of the iterative learning controller (e.g., error block 261 of FIG. 4). Retrieving the one or more iterative learning functions may include loading a set of coefficients into memory of the iterative learning controller (e.g., IL block 262 of FIG. 4) to adjust the iterative learning piecewise function for the provided reference profile.

At 506, the method 500 may include scanning a field of view of the LiDAR system based on the reference profile and one or more iterative learning functions using an output system of the LiDAR system. Scanning the field of view may include providing a set of reference signals using a reference generator (e.g., reference generator 254) of the output controller. The set of reference signals may be based on the reference profile and one or more iterative learning functions determined for the reference profile during the calibration process 400. Additionally, the iterative learning controller may add an iterative learning signal to each reference signal based on the error piecewise function and the iterative learning piecewise function. Accordingly, the iterative learning controller may provide further error correction during operation in the field that may not be needed during a calibration process.

At 508, the method 500 may include adjusting the one or more iterative learning functions based on an output of the output system and the reference profile. The output controller may provide a feedback signal from which an error signal can be determined to further correct operation a position of actuators of the LiDAR system. Accordingly, the iterative learning controller can cause the actual output to converge to the reference position when reference profiles are switched or when additional sources of error are encountered during operation.

At 510, the method 500 may include determining whether a new profile has been requested. A new profile may be requested by the controller of the LiDAR system and/or the external system. If a new profile has not been requested the method 500 may return to 508. At 508 the iterative learning function may continue to be adjusted to maintain convergence of measured and reference positions. If a new profile has been requested, at 512, the method 500 may provide the new profile and proceed to 504. Accordingly, the process of convergence can be repeated for the new profile.

Method 500 may be implemented as part of the calibration method 400 or during operation in the field. For example, after the calibration method 400 has been completed for one or more reference profiles, the method 500 may be used to verify that calibration has been completed successfully.

The invention is defined in the claims. However, below there is provided a non-exhaustive list of non-limiting examples. Any one or more of the features of these examples may be combined with any one or more features of another example, embodiment, or aspect described herein.

Example Ex1: A method for calibrating a LiDAR system, the method comprising: providing a reference profile comprising a plurality of reference positions to an iterative learning controller of the LiDAR system; scanning a field of view of the LiDAR system based on the reference profile using an output system of the LiDAR system, the output system comprising the iterative learning controller; sampling an output position of the output system during scanning of the field of view based on the reference profile to provide a plurality of measured positions; comparing the plurality of measured positions to the plurality of reference positions to generate an iterative control data set corresponding to the reference profile; determining one or more iterative learning functions based on the iterative control data set.

Example Ex2: The method as in example Ex1, wherein the iterative control data set comprises an error feedforward table and an iterative learning control table.

Example Ex3: The method as in any one of the previous examples, wherein the output system comprises a servo and the plurality of reference positions comprises a plurality of servo positions.

Example Ex4: The method as in any one of the previous examples, wherein determining the one or more iterative learning functions comprises: associating the one or more iterative learning functions with the reference profile; storing the one or more iterative learning functions in a memory.

Example Ex5: The method as in any one of the previous examples, further comprising: initiating a scan based on the reference profile; providing the one or more iterative learning functions to the iterative learning controller in response to the scan being initiated; and scanning the field of view based on the reference profile and the one or more iterative learning functions.

Example Ex6: The method as in any one of the previous examples, wherein the one or more iterative learning functions comprises an error piecewise function.

Example Ex7: The method as in any one of the previous examples, wherein the one or more iterative learning functions comprises an iterative learning piecewise function.

Example Ex8: The method as in any one of the previous examples, wherein one or more iterative learning functions comprises a set of coefficients corresponding to the reference profile.

Example Ex9: The method as in any one of the previous examples, wherein the output system comprises at least one scanning mirror and the plurality of reference positions comprises a plurality of scanning mirror positions or angles.

Example Ex10: A method comprising: providing a reference profile comprising a plurality of reference positions to an output controller of a LiDAR system, the output controller comprising an iterative learning controller; providing one or more iterative learning functions based on the reference profile; scanning a field of view of the LiDAR system based on the reference profile and one or more iterative learning functions using an output system of the LiDAR system, the output system comprising the iterative learning controller; and adjusting the one or more iterative learning functions based on an output of the output system and the reference profile.

Example Ex11: The method as in example Ex10, further comprising: determining that a new reference profile has been requested; providing the new reference profile comprising another plurality of reference positions to the output controller; providing one or more other iterative learning functions based on the new reference profile; scanning the field of view based on the new reference profile and the one or more other iterative learning functions using the output system; and adjusting the one or more other iterative learning functions based on the output of the output system and the new reference profile.

Example Ex12: The method as in any one of examples Ex10 or Ex11, wherein the reference profile comprises the one or more iterative learning functions.

Example Ex13: The method as in any one of examples Ex10 to Ex12, wherein the one or more iterative learning functions comprises an error piecewise function.

Example Ex14: The method as in any one of examples Ex10 to Ex13, wherein the one or more iterative learning functions comprises an iterative learning piecewise function.

Example Ex15: The method as in any one of examples Ex10 to Ex14, wherein one or more iterative learning functions comprises a set of coefficients corresponding to the reference profile.

Example Ex16: A LiDAR system comprising: an emitter to emit light pulses within a field of view of the LiDAR system, the emitter comprising: a light emitter to generate the light pulses; and an output system operatively coupled to the light emitter to control a position of the emitted light pulses within the field of view based on a selected reference profile, the output system comprising an iterative learning controller configured to provide an error correction signal based on one or more iterative learning functions that correspond to the selected reference profile; and a detector to provide one or more detection signals in response to receipt of a return pulse corresponding to light pulses emitted by the emitter.

Example Ex17: The LiDAR system as in example Ex16, wherein the emitter control system further comprises: one or more scanning mirrors each comprising one or more reflective surfaces; and one or more servos operatively coupled to the one or more scanning mirrors to change a position of the one or more reflective surfaces based on the selected reference profile and the error correction signal.

Example Ex18: The LiDAR system as in any one of examples Ex16 or Ex17, wherein selected reference profile is selected from a plurality of reference profiles.

Example Ex19: The LiDAR system as in any one of examples Ex16 to Ex18, further comprising a controller operatively coupled to the emitter and the detector, the controller configured to provide the selected profile to the emitter control system.

Example Ex20: The LiDAR system as in any one of examples Ex16 to Ex19, wherein the one or more iterative learning functions comprises an iterative learning piecewise function.

Example Ex21: The LiDAR system as in any one of examples Ex16 to Ex20, wherein the one or more iterative learning functions comprises an error piecewise function.

Example Ex22: The LiDAR system as in any one of examples Ex16 to Ex21, wherein the one or more iterative learning functions comprises a set of coefficients corresponding to the reference profile.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a light emitter configured to emit light pulses; and
a controller configured to control positions of the emitted light pulses based on a selected reference profile, the controller comprising an iterative learning controller configured to provide an error correction signal based on one or more iterative learning functions that correspond to the selected reference profile; and
a detector configured to provide one or more detection signals in response to a detection of a return pulse corresponding to at least one of the emitted light pulses.

2. The system of claim 1, further comprising:
one or more scanning mirrors comprising one or more reflective surfaces; and
one or more servos operatively coupled to the one or more scanning mirrors configured to change a position of the one or more reflective surfaces based on the selected reference profile and the error correction signal.

3. The system of claim 1, further comprising:
a processor configured to adjust the one or more iterative learning functions based on a detected position of one or more scanning components controlled by the controller.

4. The system of claim 1, wherein selected reference profile is selected from a plurality of reference profiles.

5. The system of claim 1 wherein the one or more iterative learning functions comprises an iterative learning piecewise function.

6. The system of claim 1, wherein the one or more iterative learning functions comprises an error piecewise function.

7. The system of claim 1, wherein the one or more iterative learning functions comprises a set of coefficients corresponding to the reference profile.

8. A method, comprising:
providing a reference profile associated with a plurality of reference positions to an iterative learning controller of a LiDAR system;
operating one or more scanning components of the LiDAR system based on the reference profile;
measuring a plurality of positions of the one or more scanning components;
comparing the plurality of measured positions to the plurality of reference positions to generate an iterative control data set associated with the reference profile; and
determining one or more iterative learning functions based on the iterative control data in set.

9. The method of claim 8, wherein the iterative control data set comprises an error feedforward table and an iterative learning control table.

10. The method of claim 8, wherein the one or more scanning components comprises a servo and the plurality of reference positions comprises a plurality of servo positions.

11. The method of claim 8, wherein determining the one or more iterative learning functions comprises:
associating the one or more iterative learning functions with the reference profile; and
storing the one or more iterative learning functions in a memory.

12. The method of claim 8, further comprising:
initiating a scan;
providing the one or more iterative learning functions to the iterative learning controller in response to the scan being initiated; and
scanning at least a portion of a field of view based on the reference profile and the one or more iterative learning functions.

13. The method of claim 8, wherein the one or more iterative learning functions comprises an error piecewise function.

14. The method of claim 8, wherein the one or more iterative learning functions comprises an iterative learning piecewise function.

15. The method of claim 8, wherein one or more iterative learning functions comprises a set of coefficients corresponding to the reference profile.

16. The method of claim 8, wherein the one or more scanning components comprises at least one scanning mirror and the plurality of reference positions comprises a plurality of scanning mirror positions or angles.

17. A method, comprising:
providing a reference profile associated with a plurality of reference positions to an iterative learning controller of a LiDAR system;
operating one or more scanning components of the LiDAR system based on the reference profile;
measuring a plurality of positions of the one or more scanning components;
comparing the plurality of measured positions to the plurality of reference positions to generate an iterative control data set associated with the reference profile; and
adjusting one or more iterative learning functions based on the iterative control data set.

18. The method of claim 17, wherein the one or more iterative learning functions comprises an error piecewise function.

19. The method of claim 17, wherein the one or more iterative learning functions comprises an iterative learning piecewise function.

20. The method of claim 17, wherein one or more iterative learning functions comprises a set of coefficients corresponding to the reference profile.
